(19) United States
(12) Patent Application Publication
(10) Pub. No.: US 2016/0217766 A1
(43) Pub. Date: Jul. 28, 2016

(54) System and Method for Sub-Pixel Color Management

(71) Applicant: Dell Products, LP, Round Rock, TX (US)

(72) Inventor: Stefan Peana, Austin, TX (US)

(21) Appl. No.: 14/604,405

(22) Filed: Jan. 23, 2015

(51) Int. Cl. G09G 5/06

(52) U.S. Cl. CPC G09G 5/06; G09G 2340/06; G09G 2340/0457; G09G 2310/08; G09G 2360/02

(57) ABSTRACT

An information handling system includes a a graphics processing unit and a display with a timing controller. The graphics processing unit can receive an input image comprising three color values for pixels of the input image, and map the pixels of the input image to pixels of the display. The graphics processing unit can provide three-color sub-pixel values to the timing controller, and the timing controller can perform a color calibration of the image using three dimensional look up tables to produce four-color sub-pixel values. Alternatively, the graphics processing unit can perform the color calibration and provide the four-color sub-pixel values to the timing controller. In another alternative, the graphics processing unit can perform the color calibration and provide the timing controller with three-color sub-pixel values, and the timing controller can generate four-color sub-pixel values from the combination of the three-color sub-pixel values and a chrominance value.

### FIELD OF THE DISCLOSURE

The present disclosure relates to sub-pixel color management for information handling systems.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a diagram illustrating a surface view of a display;

FIG. 3 is a cross-sectional view of a display;

FIGS. 4A, 4B, and 4C are diagrams illustrating various sub-pixel configurations;

FIGS. 5, 6, and 7 are a block diagrams illustrating various exemplary systems for sub pixel color management; and

FIG. 8 is a flow diagram illustrating an exemplary method of determining a white sub-pixel value based on a calculated chrominance.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

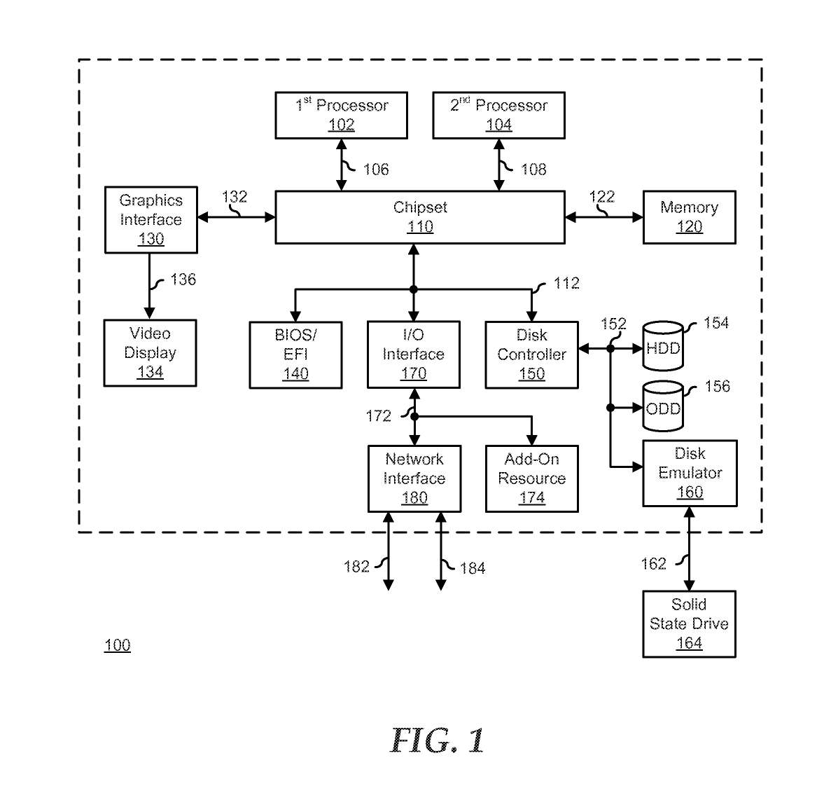

FIG. 1 illustrates a generalized embodiment of information handling system 100. For purpose of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smart phone, a tablet device or other consumer electronic device, a network server, a network storage device, a switch router or other network communication device, or any other suitable device and may vary in size, shape, performance, functionality, and price, Further, information handling system 100 can include processing resources for executing machine-executable code, such as a central processing unit (CPU), a programmable logic array (PLA), an embedded device such as a System-on-a-Chip (SoC), or other control logic hardware. Information handling system 100 can also include one or more computer-readable medium for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

Information handling system 100 can include devices or modules that embody one or more of the devices or modules described above, and operates to perform one or more of the methods described above. Information handling system 100 includes a processors 102 and 104, a chipset 110, a memory 120, a graphics interface 130, include a basic input and output system/extensible firmware interface (BIOS/EFI) module 140, a disk controller 150, a disk emulator 160, an input/output (I/O) interface 170, and a network interface 180, Processor 102 is connected to chipset 110 via processor interface 106, and processor 104 is connected to chipset 110 via processor interface 108. Memory 120 is connected to chipset 110 via a memory bus 122. Graphics interface 130 is connected to chipset 110 via a graphics interface 132, and provides a video display output 136 to a video display 134. In a particular embodiment, information handling system 100 includes separate memories that are dedicated to each of processors 102 and 104 via separate memory interfaces. An example of memory 120 includes random access memory (RAM) such as static RAM (SRAM), dynamic RAM (DRAM), non-volatile RAM (NV-RAM), or the like, read only memory (ROM), another type of memory, or a combination thereof.

BIOS/EFI module 140, disk controller 150, and I/O interface 170 are connected to chipset 110 via an I/O channel 112. An example of I/O channel 112 includes a Peripheral Component Interconnect (PCI) interface, a PCI-Extended (PCI-X) interface, a high-speed PCI-Express (PCIe) interface, another industry standard or proprietary communication interface, or a combination thereof. Chipset 110 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/EPI module 140 includes BIOS/ER code operable to detect resources within information handling system 100, to provide drivers for the resources, initialize the resources, and access the resources. BIOS/ER module 140 includes code that operates to detect resources within information handling system 100, to provide drivers for the resources, to initialize the resources, and to access the resources.

Disk controller 150 includes a disk interface 152 that connects he disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits a solid-state drive 164 to be connected to information handling system 100 via an external interface 162. An example of external interface 162 includes a USB interface, an IEEE 1194 (Firewire) interface, a proprietary interface, or a combination thereof. Alternatively, solid-state drive 164 can be disposed within information handling system 100.

I/O interface 170 includes a peripheral interface 172 that connects the I/O interface to an add-on resource 174 and to network interface 180. Peripheral interface 172 can be the same type of interface as I/0 channel 112, or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral channel 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a NIC disposed within information handling system 100, on a main circuit board of the information handling system, integrated onto another component such as chipset 110, in another suitable location, or a combination thereof. Network interface device 180 includes network channels 182 and 184 that provide interfaces to devices that are external to information handling system 100. In a particular embodiment, network channels 182 and 184 are of a different type than peripheral channel 172 and network interface 180 translates information from a format suitable to the peripheral channel to a format suitable to external devices. An example of network channels 182 and 184 includes InfiniBand channels, Fibre Channel channels, Gigabit Ethernet channels, proprietary channel architectures, or a combination thereof. Network channels 182 and 184 can be connected to external network resources (not illustrated). The network resource can include another information handling system, a data storage system, another network, a grid management system, another suitable resource, or a combination thereof.

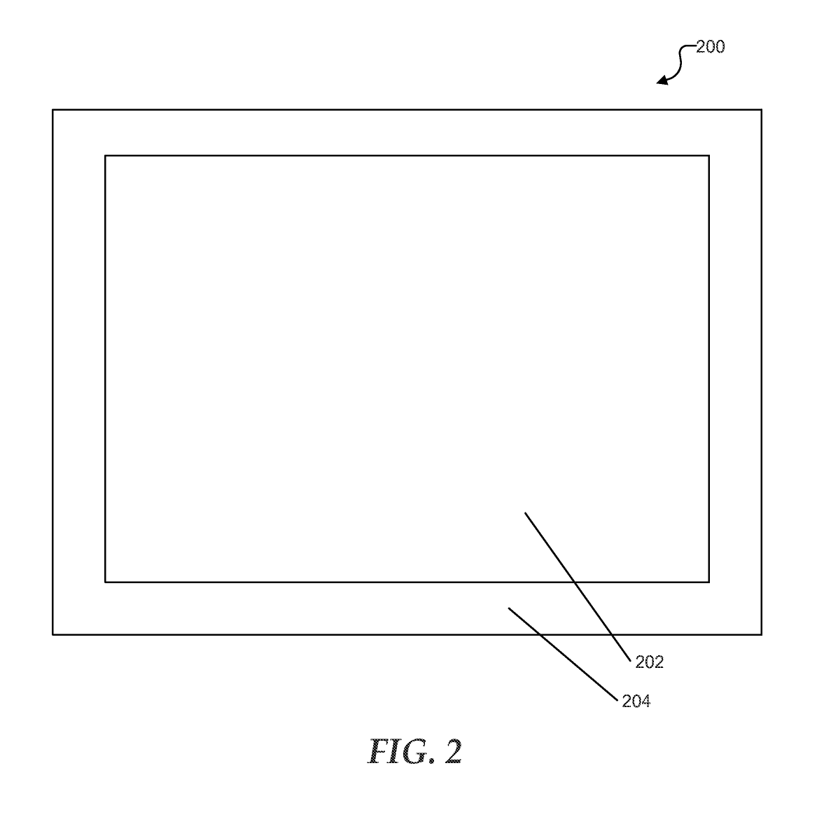

FIG. 2 illustrates a surface view of a display assembly 200. Active display area 202 can define a center portion of the display assembly surface view 200 and a bezel region 204 can define the perimeter of the display assembly surface view 200. In various embodiments, active display area 202 can also incorporate a touch sensitive area.

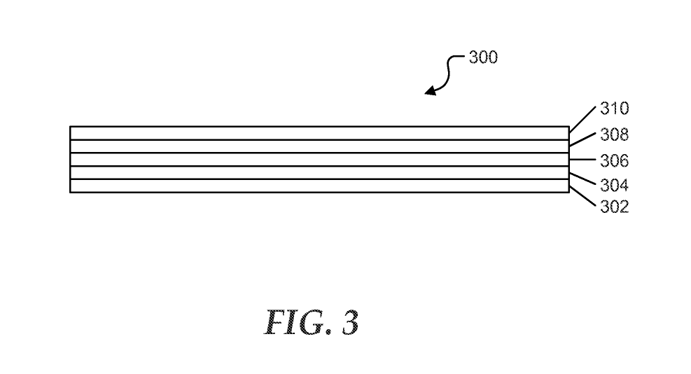

FIG. 3 illustrates a cross section of a display assembly 300. The display assembly 300 can include a display layer 302, an optically clear adhesive layer 304, an optional touch sensitive layer 306, a cover layer 308, and an antireflective coating 310. Display layer can include a liquid crystal display, an organic light emitting diode display, or other display technology. The optional touch sensitive layer 306 can include resistive touch sensors, capacitive touch sensors, or other touch sensor technologies. Optically clear adhesive layer 304 can bond the display layer and the touch sensitive layer, filling in any air gaps between the layers to improve the optical characteristics of the display assembly. Cover layer 308 can be a glass or plastic layer to protect the display layer 302 and the touch sensitive layer 306. Preferably, cover layer 308 can be a hard layer that is resistant to scratches and breakage. For example, the cover layer 308 can be Corning Gorilla glass. Cover layer 308 can be coated with a antireflective coating or film to reduce glare and reflections from the surface of the display assembly. Optionally, another optically clear adhesive layer (not shown) can be between touch sensitive layer 306 and cover layer 308.

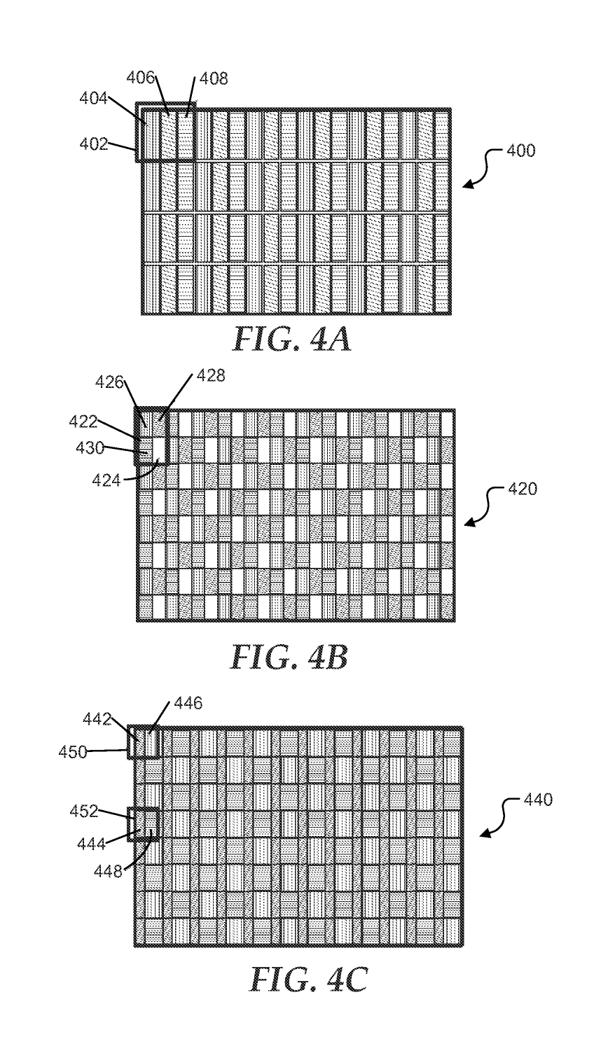

FIGS. 4A-FIG. 4C show various sub pixel configurations. Historically, displays have used combinations of red, green, and blue subpixels to generate the spectrum of colors seen by the human eye. FIG. 4A illustrates an embodiment of a standard RGB configuration with each pixel comprising a red sub-pixel, a green sub-pixel, and a blue sub-pixel. More recently, other sub-pixel configurations have been developed incorporating additional sub-pixels to improve the color quality, brightness, and dynamic range of the display.

FIG. 4B shows an exemplary RGBW configuration, which include a white (or sometimes yellow) sub-pixel in addition to the red, green, and blue sub-pixels. The white sub-pixel can be used to increase the overall transmittance of the pixel, while the red, green, and blue sub-pixels can be used to control the color of the pixel. Overall, the use of the white sub-pixel can increase the brightness of the display.

FIG. 4C shows an exemplary RGBG configuration that can be used in AMOLED (Active Matrix Organic Light Emitting Diode) and plasma displays. The RGBG configuration uses green sub-pixels interleaved with alternating red and blue sub-pixels. In various embodiments, the human eye can be most sensitive to green, especially for high resolution luminance information. The green sub-pixels can be mapped to input pixels on a one to one basis with the red and blue sub-pixels being subsampled to reconstruct the chroma signal at a lower resolution. The green sub-pixels can provide for a majority of the reconstruction of the luminance signal. While the red and blue sub-pixels can reconstruct the horizontal and vertical spatial frequencies, they may not reconstruct the highest diagonal spatial frequencies. Diagonal high spatial frequency information in the red and blue channels of the input image can be transferred to the green sub-pixels for image reconstruction. RGBG configuration can create a color display with one third fewer sub-pixels than a traditional RGB configuration but with the same measured luminance display resolution.

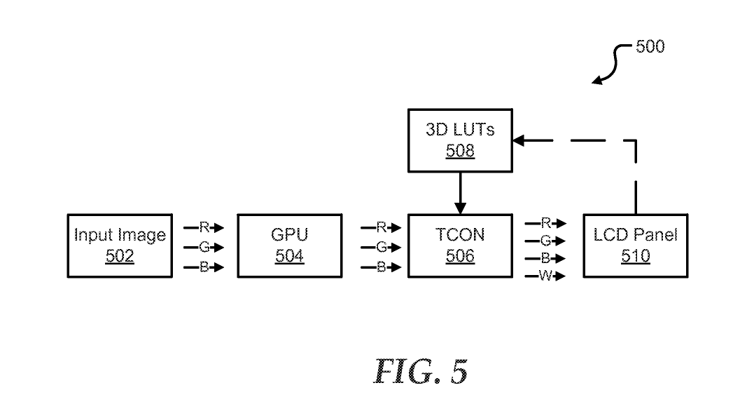

FIG. 5 shows an exemplary system 500 for sub-pixel color management. Input image 502 can be provided to graphics processing unit (GPU) 504, which may be incorporated into graphics interface 130 of FIG. 1. Input image 502 can be composed of red, green, and blue values for each pixel of the image, and the red, green, and blue values can be passed to GPU 504. GPU 504 can apply various algorithms to the image, such as mapping the image to sub-pixels of the display, enhancing sharpness and contrast, and the like. GPU 504 can supply red, green, and blue sub-pixel values to the timing controller (TCON) 506 of the display. TCON 506 can utilize three-dimensional lookup tables (3D LUTs) 508 and algorithms to perform shader calculations and to calculate a white sub-pixel value based on the red, green, and blue sub-pixel values provided by the GPU 504. The red, green, blue, and white sub-pixel values can be provided to the display panel 510 (such as in video display 134 of FIG. 1), and display panel 510 can use those sub-pixel values to display an image.

In various embodiments, the capabilities of TCON 506 are substantially higher than typical TCONs used in displays. For example, TCON 506 would need sufficient memory to store the 3D LUTs and to buffer multiple images and the ability to perform shader calculations that are commonly performed in the GPU.

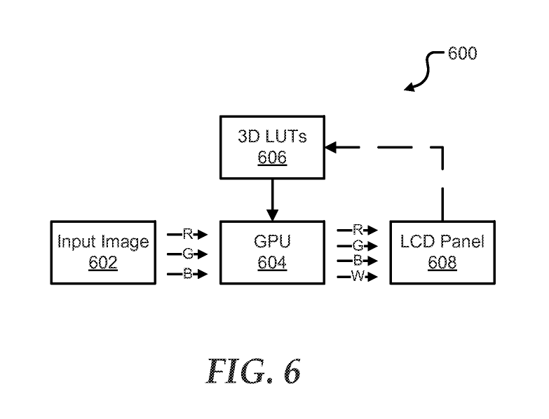

FIG. 6 is a block diagram illustrating an exemplary system 600 for sub-pixel color management. Input image 602 can be provided to graphics processing unit (GPU) 604, which may be incorporated into graphics interface 130 of FIG. 1. Input image 602 can be composed of red, green, and blue values for each pixel of the image, and the red, green, and blue values can be passed to GPU 604. GPU 604 can apply various algorithms to the image, such as mapping the image to sub-pixels of the display, enhancing sharpness and contrast, and the like. Additionally, GPU 604 can utilize 3D LUTs 606 to perform shader calculations to determine red, green, blue, and white sub-pixel values. The red, green, blue, and white sub-pixel values can be provided to the display panel 608 (such as in video display 134 of FIG. 1), and display panel 608 can use the sub-pixel values to display an image.

In various embodiments, many GPUs are configured to perform three-color calculations (red, green, and blue) and may not have the capability to perform calculations for a four-color image (red, green, blue, and white).

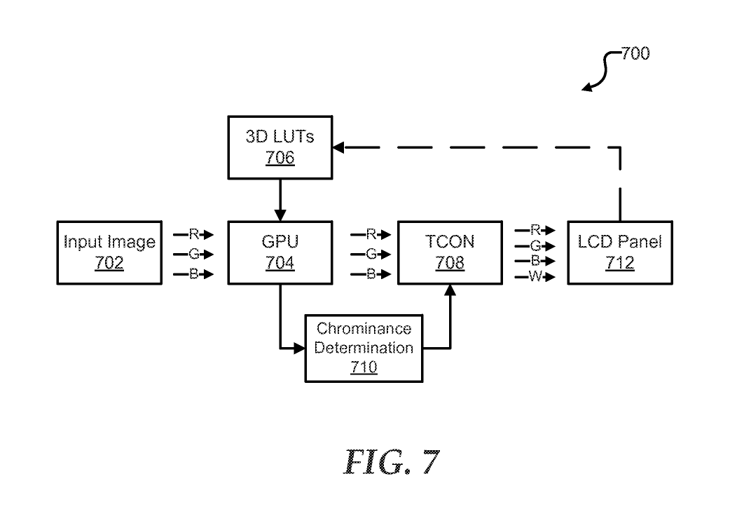

FIG. 7 is a block diagram illustrating an exemplary system 700 for sub-pixel color management. Input image 702 can be provided to graphics processing unit (GPU) 704, which, for example, may be incorporated into graphics interface 130 of FIG. 1. Input image 702 can be composed of red, green, and blue values for each pixel of the image, and the red, green, and blue values can be passed to GPU 704. GPU 704 can apply various algorithms to the image, such as mapping the image to sub-pixels of the display, enhancing sharpness and contrast, and the like. Additionally, GPU 704 can utilize 3D LUTs 706 to perform shader calculations and to calculate red, green, and blue sub-pixel values. The red, green, blue, and white sub-pixel values can be passed to TCON 708 of the display. TCON 708 can calculate a white sub-pixel value based on a chrominance calculation 710. In various embodiments, the chrominance calculation 710 can be performed by GPU 704 or by TCON 708. TCON 708 can provide the red, green, blue, and white sub-pixel values to display panel 712 (such as in video display 134 of FIG. 1), and LCD panel 712 can use those sub-pixel values to display an image.

Various methods are known in the art o calculate chrominance, such as the method disclosed in U.S. Pat. No. 8,860,781, herein incorporated in its entirety for all purposes. Generally, the system can calculate chrominance as a function of the differences in the red, green, and blue values for a pixel. The value for the white sub-pixel can be low when the chrominance is high, such as when the value for the red sub-pixel is high and the value for the green sub-pixel is low, and the value for the white sub-pixel can be similar to the red, green, and blue sub-pixel values when the chrominance is very low, such as when the value for the red, green, and blue sub-pixels are substantially similar. In various embodiments, the GPU 704 can calculate the chrominance when performing the shader calculations and provide a chrominance table to the TCON 708. The TCON 708 can utilize a lookup table of white values based on the chrominance values provided by the GPU 704. Alternatively, the TCON 708 can utilize a three dimensional lookup table and the red, green, and blue values provided by the GPU 704 to determine the chrominance or white values. In yet another embodiment, the GPU 704 can calculate the chrominance and determine the white values, and then the white values can be passed for each sub-pixel can be passed to the TCON 708. The TCON 708 can combine the RGB values and the white values to generate the RGBW values that are passed to the display panel 712.

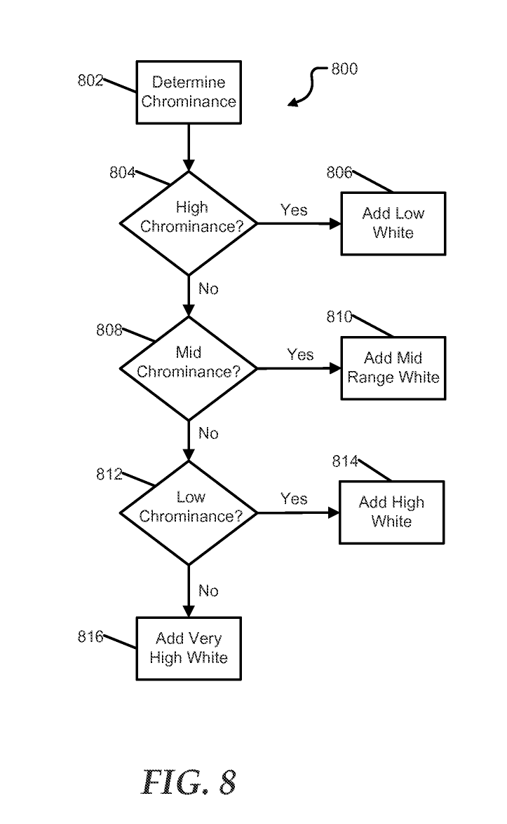

FIG. 8 is a flow diagram illustrating an exemplary method of determining a white sub-pixel value based on the calculated chrominance. At 702, the chrominance can be calculated, such as by determining the differences between the red, green, and blue sub-pixel values. For example, the chrominance value can be determined by taking the maximum of the absolute values of the differences between red and green, red and blue, and blue and green sub-pixel values. At 704, a determination can be made if the chrominance value is high, such as in a range of 128-255. When the chrominance is high, a low white, such as about 0, can be added, as shown in 706.

Alternatively, when the chrominance value is not high, at 708, determination can be made if the chrominance value is in a mid range, such as in a range of 64-127. When the chrominance is in a mid range, a mid range white, such as about 64, can be added, as shown in 710. Alternatively, when the chrominance value is not mid range, at 712, determination can be made if the chrominance value is low, such as in a range of 32-63. When the chrominance is low, a high white, such as about 128, can be added, as shown in 714.

Alternatively, when the chrominance value is not low, white can be added at a similar level to the other sonic pixel values, as shown in 716. For example, if the sub-pixel values are low, such as a black pixel, very little white can be added. In another example, if the sub-pixel values are around 128, such as a mid-range gray, the white sub-pixel value can also be around 128, and when the sub-pixel values are around 255, such as a bright white, the white sub-pixel value can be set at 255.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality.

The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system comprising:
a display including a timing controller and a display panel; and
a graphics processing unit to:
receive an input image comprising three color values for pixels of the input image;
map the pixels of the input image to pixels of the display; and
provide three-color sub-pixel values to the timing controller;
the timing controller to:
receive the three-color sub-pixel values from the graphics processing unit;
perform a color calibration of the image using three dimensional look up tables to produce four-color sub-pixel values from the three-color sub-pixel values; and
provide the four-color sub-pixel values to the display panel to produce an output image.

2. The information handling system of claim 1, wherein the three dimensional look up tables are specific for the display panel type.

3. The information handling system of claim 1, wherein the color calibration uses three dimensional look up tables to correct for display color.

4. The information handling system of claim 1, wherein the color calibration uses three dimensional look up tables to correct for ambient light conditions.

5. The information handling system of claim. 1, wherein the three-color values include red, green, and blue values.

6. The information handling system of claim 1, wherein the four-color values include red, green, blue, and white values.

7. An information handling system comprising:
a display panel; and
a graphics processing unit that:
receives an input image comprising three color values for pixels of the input image;
maps the pixels of the input image to pixels of the display;
performs a color calibration of the image using three dimensional look up tables to produce four-color sub-pixel values from the three-color sub-pixel values; and
provides the four-color sub-pixel values to the display panel to produce an output image.

8. The information handling system of claim 7, wherein the three dimensional look up tables are specific for the display panel type.

9. The information handling system of claim 7, wherein the color calibration uses three dimensional look up tables to correct for display color.

10. The information handling system of claim 7, wherein the color calibration uses three dimensional look up tables to correct for ambient light conditions.

11. The information handling system of claim 7, wherein the three-color values include red, green, and blue values.

12. The information handling system of claim 7, wherein the four-color values include red, green, blue, and white values.

13. An information handling system comprising:
a display including a timing controller and a display panel; and
a graphics processing unit to:
receive an input image comprising three color values for pixels of the input image;
map the pixels of the input image to pixels of the display;
perform a color calibration of the image using three dimensional look up tables to produce three-color sub-pixel values from the three-color sub-pixel values and
provide three-color sub-pixel values to the timing controller;
the timing controller to:
receive the three-color sub-pixel values from the graphics processing unit;
generate four-color sub-pixel values from the combination of the three-color sub-pixel values and a chrominance value; and
provide the four-color sub-pixel values to the display panel to generate an output image.

14. The information handling system of claim 13, wherein the color calibration uses three dimensional look up tables to correct for display color.

15. The information handling system of claim 13, wherein the color calibration uses three dimensional look up tables to correct for ambient light conditions.

16. The information handling system of claim 13, wherein the three-color values include red, green, and blue values.

17. The information handling system of claim 13, wherein the four-color values include red, green, blue, and white values.

18. The information handling system of claim 13, wherein the chrominance value is determined based on the three-color sub-pixel values.

19. The information handling system of claim 13, wherein the chrominance value is determined by the graphics processing unit.

20. The information handling system of claim 13, wherein the chrominance value is determined by the timing controller.
